(19) United States
(12) Patent Application Publication
(10) Pub. No.: US 2010/0054287 A1
(43) Pub. Date: Mar. 4, 2010

(54) Method and System for Laser-Based High-Speed Digital Marking of Objects

(76) Inventor: Farzan Ghauri, Chicago, IL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/204,390

(22) Filed: Sep. 4, 2008

(51) Int. Cl. H01S 3/10; H01S 3/13

(52) U.S. Cl. 372/26; 372/29.014

(57) ABSTRACT

Laser marking system and method are provided. A laser source is configured to supply a laser beam having a first optical intensity level and a respective beam cross-section. A spatial light modulator (SLM) is optically coupled to the laser source to receive the laser beam. The SLM is controlled to generate an output laser beam with an optical pattern containing a data code matrix across the beam cross-section. An optical amplifier is coupled to the SLM to receive the laser beam from the SLM and generate an amplified laser beam containing the same data code matrix as generated by the SLM. The amplified laser beam has a second optical intensity level higher relative to the first intensity level and is selectable to either ablatively or non-ablatively mark a target object with the data code matrix.

### FIELD OF THE INVENTION

The present invention is generally related to laser marking systems, and, more particularly, to a laser marking system that uses a laser amplification arrangement and a digital micromirror device (DMD).

### BACKGROUND OF THE INVENTION

A data matrix code may be used to construct a 2-dimensional (2-D) array of a visually-contrasting pattern arranged over a surface, e.g., a pattern of white and black squares. For example, the white squares may be turned on in response to a logic one bit and the black squares may be turned on in response to a logic zero bit. Depending on the size of the 2-D array, the matrix can contain encoded alphanumeric data that may range from a few bytes to several kilobytes. The information encoded within the data matrix can be used to mark objects, e.g., products. This allows product identification and traceability and can provide substantial anti-counterfeit measures.

It is known that the data matrix can be attached, placed or marked on the products by various means such as industrial ink-jet printing, electrolytic chemical etching and laser markings. Laser-based marking devices do not require inks, solvents and other chemicals and thus can provide a marking implementation that is comparatively less expensive with lower operating costs and more environmental friendly, such as without generating hazardous solvent emissions. Moreover, the laser-based markings are generally longer lasting and do not wear off easily.

A majority of presently available laser-based marking systems use galvanometer-based optical scanning technology where a laser beam is scanned across the object to be marked placing one pixel mark at a time. Although the technology has made advances in terms of speed and performance, placing a 2-D bar matrix code on the object can be challenging. For example, placing a 2-D bar matrix code with an example resolution of 1024 by 768 pixels would require 786,432 marking operations in a galvanometer-based system. On the other hand, a laser marking system based on a Micro-Electro-Mechanical-System (MEMS) device—e.g., a digital micromirror device (DMD), can simultaneously process a complete code matrix in a single operation. However, as described in greater detail below, certain drawbacks have arisen.

U.S. Pat. No. 6,836,284 describes a laser marking system using a digital micromirror device (DMD) that requires a beam expansion and beam contraction mechanism (i.e., requires optics adapted to intentionally affect the cross-section of the beam) to avoid damage to the DMD. The beam expansion spreads the optical power of an incident beam over a larger area and thus reduces the irradiance (power per unit area) so that the DMD is not damaged and after reflection from the DMD the beam is contracted again to increase the irradiance. The system described in the foregoing patent, however, is somewhat impractical since the physical dimensions and the cross-sectional area of available micromirror devices are relatively small (in the order of few square cm). Due to their small cross-sectional area, the spatial profile of the incident laser beam cannot be expanded beyond a certain magnification limit (L), as shown in FIG. 6. That is, the irradiance of the incident laser beam cannot be reduced by a factor greater than L. Any further magnification (M>L) would result in part of the beam to miss the device. Thus, in practice, the marking system proposed in the foregoing patent would not be effective for applications requiring optical intensities L times higher than the DMD damage threshold. Accordingly, it is desirable to provide a practical and reliable laser marking system that provides a cost-effective solution to overcome the above-described issues.

### BRIEF DESCRIPTION OF THE DRAWINGS

The present invention will be more readily understood and the various advantages and uses thereof more readily appreciated, when considered in view of the following detailed description when read in conjunction with the following figures, wherein:

FIG. 1 shows a schematic representation of an example embodiment of a laser marking system embodying aspects of the present invention.

FIG. 2 shows a schematic representation of another example embodiment of a laser marking system that in accordance with further aspects of the present invention may be used for marking objects with a logical complement of an original data code matrix.

FIGS. 3 and 4 illustrate respective examples of two-dimensional (2-D) data code matrixes as may be sequentially configured with a spatial light modulator (SLM), which is a component of the systems respectively illustrated in FIGS. 1 and 2.

FIG. 5 shows a schematic representation of an example embodiment a multi-pass mirror array optical amplifier that may be a component of the systems respectively illustrated in FIGS. 1 and 2.

FIG. 6 graphically illustrates some of the practical limitations of a prior-art laser marking system based on a beam expansion-contraction mechanism that intentionally changes the spatial profile (i.e., cross-section) of a laser beam used by such a system.

### DETAILED DESCRIPTION OF THE INVENTION

In accordance with one or more embodiments of the present invention, systems and methods for laser-based marking are described herein. In the following detailed description, various specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise indicated.

A laser marking system 8 embodying aspects of the present invention uses a semiconductor-based, digitally-controlled and programmable micro-electromechanical system (MEMS) device configured to operate as a spatial light modulator (SLM) by way of an array (e.g., thousands) of individually-addressable, tiltable micro-mirror pixels. One example of such a device is known in the art as a digital micromirror device (DMD) available from Texas Instruments Inc. For readers desirous of general background information regarding basic components of the DMD and some example illustrations of the versatility of the DMD, reference is made to a paper titled “Emerging Digital Micromirror Device (DMD) Applications” by D. Dudley, W Duncan and J. Slaughter, which paper is herein incorporated by reference.

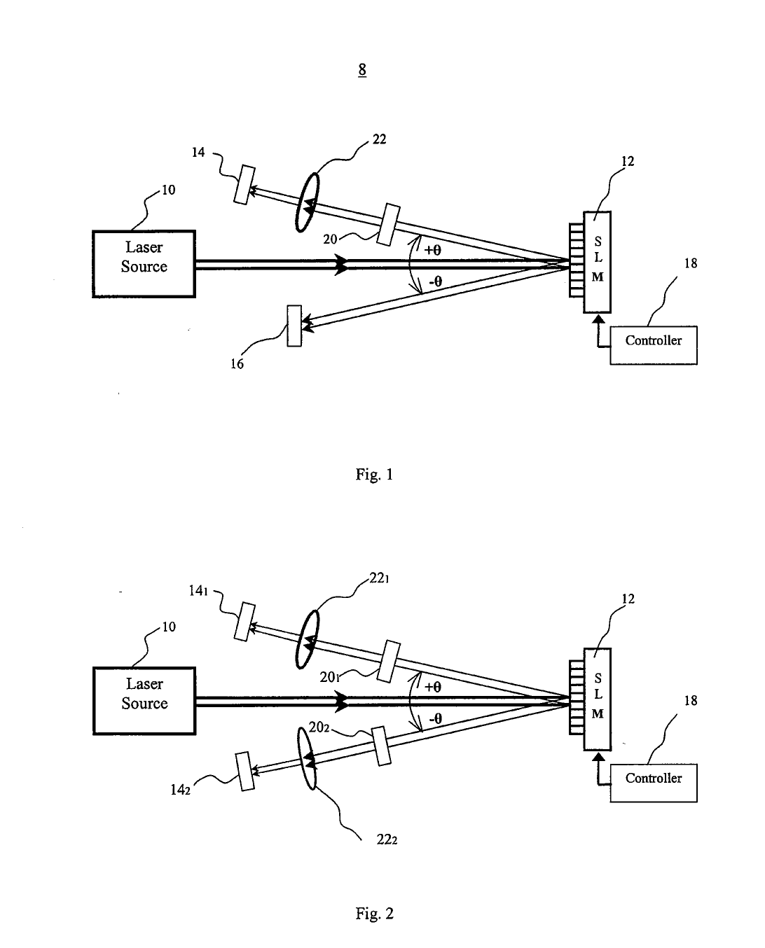

As shown in FIG. 1, a laser light source 10, e.g., a continuous wave (CW) source or a pulsed laser source, may be arranged so that laser light from source 10 strikes an SLM 12 (e.g., the above-described DMD) at normal incidence, for example. As one skilled in the art would appreciate, in the example case of Gaussian laser beam propagation, the laser beam may be in a collimated state at its minimum beam waist location and thus in one example embodiment the incident laser light source may be controlled such that the beam has its minimum beam waist at a receiving surface of SLM 12 (e.g., through a fiber gradient index lens coupled to a fiber carrying the incident laser).

In operation each micromirror (in the array of individually controllable, tiltable mirror-pixels in SLM 12) can have two tilt states. For example, a first state when the micromirror is tilted by an angle +θ and a second state when the micromirror is tilted by an angle of −θ with respect to the normal to the device surface. When the micromirror is in a tilt state set at +θ, the micromirror will reflect the laser light in a direction towards a target object 14. Conversely, when the micromirror is set in a tilt state of −θ, the micromirror will reflect the laser light away from the target object. For example, towards an optical absorber/block 16, as shown in FIG. 1.

Thus, when a respective 2-D data matrix code is supplied to SLM 12 through a controller 18, respective ones of the individually-controllable array of micromirrors in SLM 12 will be set to a respective +θ tilt state for each bit corresponding to a logic one in a given data code matrix. Similarly, respective ones of the individually-controllable array of micromirrors in SLM 12 will be set to a respective −θ tilt state for each bit corresponding to a logic zero in the given data code matrix.

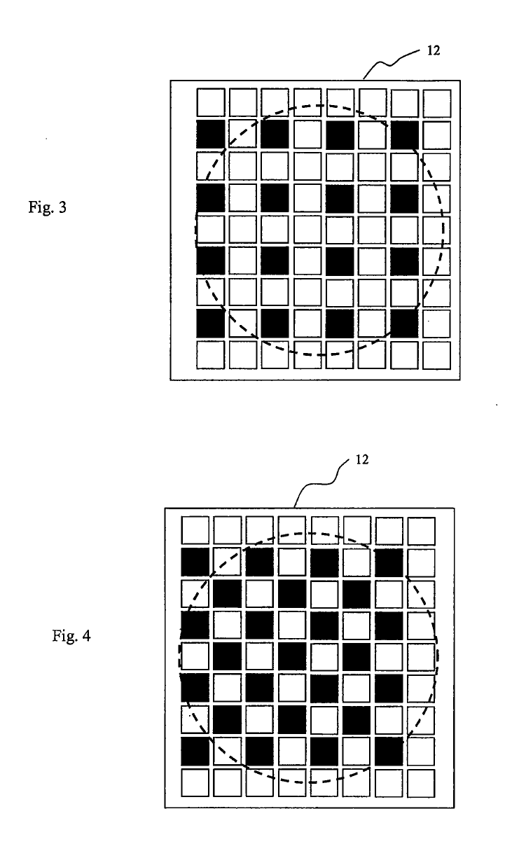

FIGS. 3 and 4 illustrate respective examples of 2-D data code matrixes as may be sequentially constructed by SLM 12. Each respective micromirror in the +θ tilt state will contribute to form an output laser beam that comprises an optical pattern containing the data code matrix. This beam is directed towards target object 14. Conversely, each respective micromirror in the −θ tilt state will contribute to form an output laser beam directed away from target object 14, e.g., towards optical light absorber/block 16.

It will be appreciated that as target object 14 is marked with an intended 2-D matrix code, the beam incident on absorber/block 16 will contain an optical pattern that is the logical complement of the data code matrix or complementary code information. Thus, for marking applications where complimentary 2-D matrix codes may be desirable, the absorber/block 16 may be eliminated and both beams (e.g., the first beam generated in response to a +θ tilt state and the second beam generated in response to a −θ tilt state) can be used for marking products 14₁ and 14₂, as shown in FIG. 2. That is, one beam may be used for marking the original data code matrix and the other beam may be used for marking the logical complement of the original data code matrix. In this latter case, as can be appreciated in FIG. 2, in lieu of absorber/block 16, the optical components (to be described below in the context of FIG. 1) to use would be essentially a duplicate of those shown in the optical path for the beam resulting when the mirrors are in the +θ tilt state.

As previously discussed, the magnitude of the incident laser beam irradiance can damage SLM 12. The inventor of the present invention has recognized (through use of optical amplifying techniques) an innovative solution to the problem of avoiding damage to the micromirror device. Opposite to the description of U.S. Pat. No. 6,836,284, the solution found by the inventor of the present invention is not contingent on beam expansion and beam contraction. That is, in the solution found by the inventor of the present invention, the final irradiance of the beam can be significantly larger than the damage threshold of the SLM 12 and the 2-D data code carried within the cross-section of the beam remains essentially unchanged. Consequently, aspects of the present invention, in a simple and elegant manner overcome the practical spatial and irradiance limitations that arise in the context of a marking system that relies on beam expansion and beam contraction, as described in the foregoing patent.

Consistent with the practical constraints of SLM 12, an appropriate level of energy (e.g., <a predefined threshold level needed for reliable DMD operation) is established for the laser beam incident on the SLM 12 so that such a device is not damaged and functions with a substantially high level of reliability. In one example embodiment, SLM 12 may safely accept 10 W/cm² of incident optical power in an example wavelength range from approximately 420 nm to approximately 700 nm. Furthermore, in the example case of a pulsed laser operation, a reliable operating energy level of approximately 0.1 J/cm² has been reported for a commercially available DMD. Thus, in this example case, the energy level of the incident laser beam should be kept below this threshold energy level.

The beam after reflection from SLM 12 is optically coupled to an optical amplifier 20 configured to boost the beam intensity to a level sufficiently high so that the beam can be used to mark the target object. It is contemplated that a system embodying aspects of the present invention can be advantageously used to provide both ablative or non-ablative marks on substances that require higher irradiances for marking. As will be readily understood by one skilled in the art, a non-ablative mark may be achieved through color change of the actual marked object or a coating, under the influence of the incident laser irradiance.

In one example embodiment, optical amplifier 20 may be composed of a gain medium and an array of mirrors. In one example embodiment the gain medium comprises essentially the same medium as that of the input laser. The gain medium of optical amplifier 20, under stimulated emission, adds a substantial number of photons to the input beam, thus making the energy content of the output beam higher relative to the energy content of the input beam. Accordingly, the optical amplifier provides a significant energy enhancement to the input beam without modifying the spatial profile (e.g., size of beam diameter) of the laser beam. Moreover, the amplification process does not affect the 2-D code information carried by the laser beam received by the amplifier. That is, the amplified laser beam generated by optical amplifier 20 contains the same data code matrix as generated by spatial light modulator 12.

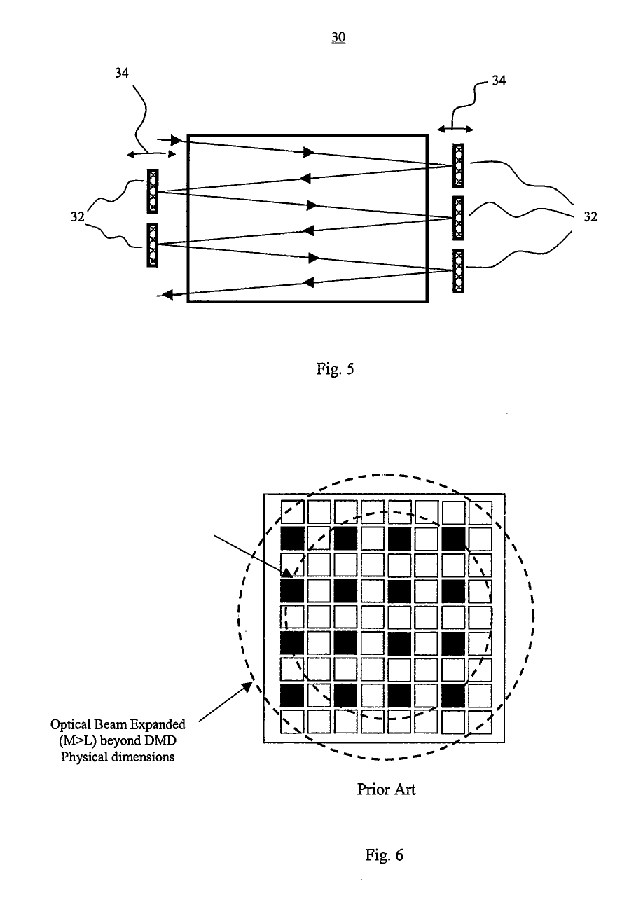

Since any additional pass through the gain medium of the laser amplifier will provide an incremental amplification to the input beam, in one example embodiment a multi-pass amplifier 30 having a mirror-array 32 may be used as the optical amplifier, as illustrated in FIG. 5. Since the mirrors used in the mirror-array optical amplifier are substantially larger in physical size than the DMD micromirrors, for purposes of distinction such mirrors may be referred herein as bulk-mirrors. It will be appreciated that various optical amplifier architectures may be used in the system design, such as multi-pass mirror-array amplifier, regenerative resonator optical amplifier etc. The mirror-array amplifier is presented here because of its simplicity of design, configuration and relatively high amplification capability. For readers desirous of general background information regarding laser amplifiers, reference is made to section 8.6 of textbook by William T. Silfvast, titled “Laser Fundamentals,” available from Cambridge University, 1996, which section is incorporated by reference herein.

The array of bulk-mirrors 32 may be selectively positioned relatively to an incident passing laser beam (e.g., via a tilt control arrangement represented by twin-headed arrow 34) to reflect the passing laser beam a number of times through the amplifying medium. As seen in FIG. 4, the passing beam propagates through a different optical path across the medium each time to make effective use of the available volume of the amplifying medium. By changing the tilt angle of the bulk mirrors, one can control the number of the times the beam passes through the amplifying medium and hence one can selectively control the optical amplification provided by multi-pass amplifier 30 to the optical beam carrying the 2-D code. It will be appreciated by one skilled in the art, that the optical intensity that can be provided by multi-pass optical amplifier 30 can be substantially higher relative to the limits imposed by the prior art. As a result, a system embodying aspects of the present invention can be used to provide both ablative and non-ablative marks on substances that require higher irradiances for marking.

Returning to FIG. 1, a variable optical-conditioning system 22 is coupled to receive the amplified output beam from optical amplifier 20. The optical-conditioning system may be composed of collimating and aplanat focusing lenses. As one skilled in the art of lens optics would recognize, an aplanat lens is designed to be substantially free of spherical and/or coma wave-front errors or aberrations. The presence of either of these aberrations could distort an optical transmitting wave-front and could cause the final focus spot on the surface of the marked test object to become irregularly shaped or blurred. The amplified beam after passing through the amplifier 20 contains the optical pattern having the 2-D matrix code imparted by SLM 12 (e.g., in terms of intense laser light for logic one bits and no light for logic zero bits). In one example embodiment, optical-conditioning system 22 may be arranged to capture the amplified beam, and then project and focus the optical pattern containing the 2-D code on the surface of the target object 14 to be marked. In one example embodiment, the optical-conditioning system 22 may do so by capturing the beam with its minimum beam waist at the surface of the SLM 12 and containing the 2-D code. It then focuses the beam on the target object such that the irradiance is further increased and the laser beam is again collimated at the surface of the target object. In one example embodiment, the regions on the surface of the target object that receive intense laser light (e.g., corresponding to logic one bits) get marked (or ablated) whereas other regions (e.g., corresponding to logic zero bits) experience no change. Thus, in this manner, the 2-D data code matrix is marked on the surface of the target object. Depending on the needs of any given marking application, optical-conditioning system 22 can be adjusted to magnify or reduce the size of the optical pattern that contains the 2-D code matrix.

In operation, the orientation of the micromirrors of SLM 12 and hence the optical pattern that contains the 2-D code information can be rapidly changed through controller 18. If a given 2-D code can be represented as a code frame, the ability of the SLM 12 to re-orient its mirrors orientation and project new code frames at a substantially high frame rate, allows a laser marking system embodying aspects of the present invention to mark products with sequentially-changing code matrices and thus advantageously allows serialized laser marking of products at substantially high speeds. The high marking speed would allow numerous industries to incorporate the marking system in existing industrial production lines without affecting associated production processes.

It will be appreciated that during the serialized (e.g., sequential) laser marking process, the DMD is stationary since its spatial light modulating operation is implemented through changes in the orientation of its micromirrors. In one example embodiment, the products to be marked may be placed on a conveyer belt or a similar mechanism for moving objects and such products are marked under the action of amplified laser irradiance as they move.

In one example embodiment, SLM 12 can operate in various regions of the frequency spectrum of light, such as ultraviolet (UV), visible and near-infrared (IR) spectral ranges. Thus the wavelength of the incident laser beam can be suitably adjusted based on the type of material being marked. It will be appreciated that various characteristics of the laser irradiance induced mark may be similarly adjusted. By way of example and not of limitation, other laser parameters that may be suitably adjusted may include energy/power, spot size (for both CW and pulsed lasers), pulse width and pulse repetition rate (for pulsed lasers).

In operation, aspects of the present invention offer a two-dimensional laser marking system and a corresponding method that allow to take full advantage of a pixilated MEMS-based DMD. This is conducive to high-speed processing of an entire code matrix in a single operation and allows a relatively high-speed serial-marking of products. In one example application, it is contemplated that the relatively high marking speed afforded by a system and method embodying aspects of the present invention would allow numerous industries to incorporate the marking system and method described herein in existing industrial production lines without affecting such production lines, e.g., without reducing their customary speeds and providing versatility for ablatively or non-ablatively marking of objects.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A laser marking system comprising:
a laser source configured to supply a laser beam having a first optical intensity level and a respective beam cross-section;
a spatial light modulator optically coupled to the laser source to receive the laser beam, wherein the spatial light modulator is controlled to generate an output laser beam comprising an optical pattern containing a data code matrix across the beam cross-section; and
an optical amplifier coupled to the spatial modulator to receive the laser beam from the spatial light modulator and generate an amplified laser beam containing the same data code matrix as generated by the spatial light modulator, the amplified laser beam from the optical amplifier having a second optical intensity level higher relative to the first intensity level and selectable to ablatively or non-ablatively mark a target object with the data code matrix.

2. The laser marking system of claim 1, wherein the optical amplifier is a multi-pass optical amplifier.

3. The laser marking system of claim 1, wherein the optical amplifier is a multi-pass optical amplifier comprising an array of mirrors for reflecting the received laser beam through an optical gain medium therein.

4. The laser marking system of claim 3, wherein the optical amplifier further comprises a mirror tilt control configured to position at least some of the mirrors in the array of mirrors to control a number of times that the received laser beam passes through the optical gain medium.

5. The laser marking system of claim 3, wherein the array of mirrors is arranged to pass the received laser beam through different optical paths distributed over a volume of the optical gain medium.

6. The laser marking system of claim 1, wherein the spatial light modulator is configured to generate a second output laser beam comprising an optical pattern containing a logical complement of the data code matrix.

7. The laser marking system of claim 6, further comprising a second optical amplifier coupled to the spatial modulator to receive the second laser beam from the spatial light modulator and generate a second amplified laser beam containing the logical complement of the data code matrix as generated by the spatial light modulator, the second amplified laser beam from the optical amplifier having a second optical intensity level higher relative to the first intensity level and selectable to ablatively or non-ablatively mark the target object with the logical complement of the data code matrix.

8. The laser marking system of claim 1, further comprising a controller electrically coupled to the spatial light modulator, the controller configured to generate a sequence of data code matrixes to be modulated by the spatial light modulator so that the generated output laser beam comprises a sequence of optical patterns containing the sequence of data code matrixes.

9. The laser marking system of claim 1, wherein the laser light source is arranged so that the laser beam supplied by the source has a minimum beam waist at a receiving surface of the SLM.

10. The laser marking system of claim 1, further comprising an optical-conditioning system coupled to the optical amplifier to receive the amplified laser beam and configured to remove spherical and/or coma wave-front optical aberrations in the amplified laser beam.

11. A method for laser marking objects, the method comprising:
generating a laser beam having a first optical intensity level and a respective beam cross-section;
optically coupling a spatial light modulator to receive the generated laser beam;
controlling the spatial light modulator to generate an output laser beam comprising an optical pattern containing a data code matrix across the beam cross-section;
optically coupling an optical amplifier to the spatial modulator to receive the laser beam from the spatial light modulator;
optically amplifying the received laser beam from the spatial light modulator to generate an amplified laser beam containing the same data code matrix as generated by the spatial light modulator, the amplified laser beam having a second optical intensity level higher relative to the first intensity level and selectable to ablatively or non-ablatively mark the target object with the data code matrix.

12. The laser marking method of claim 11, wherein the optically amplifying comprises passing a number of times the received laser beam through an optical gain medium.

13. The laser marking method of claim 12, wherein the passing of the received laser beam comprises directing the received laser beam through the optical gain medium by way of an array of mirrors.

14. The laser marking method of claim 13, further comprising positioning at least some of the mirrors in the array of mirrors to control the number of times that the received laser beam passes through the optical gain medium.

15. The laser marking method of claim 13, wherein the passing of the received laser beam comprises passing the received laser beam through different optical paths distributed over a volume of the optical gain medium.

16. The laser marking method of claim 13, further comprising generating a second output laser beam comprising an optical pattern containing a logical complement of the data code matrix.

17. The laser marking method of claim 16, further comprising optically amplifying the second laser beam to generate a second amplified laser beam containing the logical complement of the data code matrix as generated by the spatial light modulator, the second amplified laser beam having a second optical intensity level higher relative to the first intensity level and selectable to ablatively or non-ablatively mark the target object with the logical complement of the data code matrix.

18. The laser marking method of claim 11, further comprising controlling the spatial light modulator so that the generated output laser beam comprises a sequence of optical patterns corresponding to a sequence of data code matrixes applied to the spatial light modulator.

19. The laser marking method of claim 11, further comprising arranging the generated laser beam to have a minimum beam waist at a receiving surface of the SLM.

20. The laser marking method of claim 11, further comprising removing spherical and/or coma wave-front optical aberrations in the amplified laser beam.
